(19) United States
(12) Patent Application Publication
(10) Pub. No.: US 2002/0116838 A1
(43) Pub. Date: Aug. 29, 2002

(54) Impinging stream dryer

(75) Inventors: Peter Kahl, Gerstetten (DE); Markus Oechsle, Bartholomae (DE); Roland Mayer, Heidenheim (DE)

Correspondence Address: GREENBLUM & BERNSTEIN, P.L.C., 1941 ROLAND CLARKE PLACE, RESTON, VA, 20191, US

(73) Assignee: VOITH PAPER PATENT GmbH, Heidenheim (DE)

(21) Appl. No.: 10/059,333

(22) Filed: Jan. 31, 2002

(30) Foreign Application Priority Data
Feb. 28, 2001 (DE) 101 09 525.2

(51) Int. Cl. F26B 11/02; F26B 3/00

(52) U.S. Cl. 34/444; 34/116

(57) ABSTRACT

Impinging stream dryer and process for drying a fibrous material web that includes an air-permeable, endlessly circulating support belt structured and arranged to support a side of the fibrous material web, a device for impinging an opposite side of the fibrous material web with an impinging stream, and a belt cooling device arranged to cool at least an edge zone of said support belt that is directly impinged with the impinging stream.

### CROSS-REFERENCE TO RELATED APPLICATIONS

The present application claims priority under 35 U.S.C. §119 of German Patent Application No. 101 09 525.2, filed on Feb. 28, 2001, the disclosure of which is expressly incorporated by reference herein in its entirety.

### BACKGROUND OF THE INVENTION

1. Field of the Invention

The invention relates to an impinging stream dryer for drying a paper, cardboard, tissue or another fibrous material web, in which the fibrous material web is impinged on one side with a hot air and/or superheated steam impinging stream and is supported on the opposite side on an air-permeable, endlessly circulating support belt.

2. Discussion of Background Information

Such impinging stream dryers are known, for example, from DE 19841768 A1, where they are part of the drying section of a paper machine. The temperature of the hot air or the superheated steam can thereby reach values of between about 300° and 500° C. In contrast, the temperature stability of the relevant support belts, particularly because of the plastic content, is between about 140 and 240° C.

As the fibrous material web provides a sufficient heat insulation towards the support belt, essentially only the areas of the support belt that it does not cover, i.e., the edges, are thermally endangered.

In order to deal with this, the width of the impinging stream dryer is mostly limited to the web width; however, this entails difficulties or considerable expense with changing width of the fibrous material web.

The reduction of the temperature of the flow towards the edges of the fibrous material web was also suggested. However, the finding was that this impairs the drying result.

### SUMMARY OF THE INVENTION

The present invention provides a simple thermal protection of the support belt without significantly impairing the drying of the fibrous material web.

According to the invention, at least the edge zone of the support belt directly impinged with the hot air and/or superheated steam impinging stream is cooled. The cooling of the endangered area of the supporting belt on each rotation protects the support belt sufficiently without impairing the drying of the fibrous material web. To this end, it is mostly sufficient if the edge of the support belt not covered by the fibrous material web is cooled.

Moreover, in the case of a broader design of the cooled area of the support belt, i.e., cooling into the edge area of the fibrous material web, no readjustment is necessary in the case of changing web widths of the fibrous material web. It is an advantage particularly for this if the cooling of the support belt occurs after the transfer of the fibrous material web from it to a following unit.

In general, the edge of the support belt is thereby cooled in an area of between about 50 and 1000 mm. Above all if the cooled area is very wide or even extends over the entire support belt, it is often advantageous if the cooling of the support belt occurs at different intensities in cooling zones delineated transverse to the web running direction. This makes it possible to adapt the necessary cooling intensity, for instance, to the local temperature of the support belt. There are also advantages here if the cooling capacity assigned to the cooling zones can be controlled separately. Here the cooling of the support belt is made by at least one cooling device in the form of liquid and/or compressed air nozzles. To this end, a liquid is to be fed to the liquid nozzles, the boiling temperature of which is lower than the maximum admissible temperature of the support belt, preferably water or alcohols, such as polyethylene glycol. With adequate liquid feed, this evaporative cooling prevents the temperature of the support belt rising above the boiling temperature of the liquid. In order to relieve the surroundings of the machine and to prevent a rewetting of the fibrous material web, the liquid that rebounded from the support belt and/or the liquid mist emanating from it should be drawn off by control elements and/or collecting devices and/or suction devices.

To influence the cooling capacity, it should be possible to control the pressure and/or the flow rate of the liquid and/or compressed air nozzles preferably individually or zonally. This makes it possible to adjust the cooling capacity depending on the heating capacity of the impinging stream dryer, preferably to control it and/or regulate it depending on the temperature of the support belt, particularly the temperature of the affected cooling zone, and/or to control it depending on an upstream tear recognition of the fibrous material web. To this end, temperature sensors to measure the temperature of the support belt in the web running direction in front of and, under certain circumstances, after the cooling device are helpful, and they should be arranged in particular opposite the edge of the support belt. For comparison purposes, the measurement of the temperature of the support belt in the central area is advantageous.

In general, the supporting band should be embodied as a screen. Moreover, it is advantageous for ensuring a stable action of the support belt and thus also of the fibrous material web and with regard to the distance from the impinging stream dryer, if the support belt is guided over a rotating backup roll during the impinging of the fibrous material web with the hot air and/or superheated steam impinging stream. One constructively simple solution results when the hot air and/or superheated steam impinging stream is produced by a drying hood arranged in a circumferential area of the backup roll.

The cooling of the support belt according to the invention can also be used with hot air airborne web dryers.

The cooling of the support belt can take place outside the area guiding the fibrous material web, if necessary, at several places along the course of the support belt.

The instant invention is directed to an impinging stream dryer for drying a fibrous material web that includes an air-permeable, endlessly circulating support belt structured and arranged to support a side of the fibrous material web, a device for impinging an opposite side of the fibrous material web with an impinging stream, and a belt cooling device arranged to cool at least an edge zone of said support belt that is directly impinged with the impinging stream.

In accordance with a feature of the present invention, the fibrous material web can include one of a paper, cardboard, and tissue web.

According to another feature of the invention, the impinging stream may include at least one of a hot air and a superheated steam impinging stream.

The cooling device can be positioned so that the cooling of the support belt occurs after a transfer of the fibrous material web the support belt to a downstream device.

Further, the at least the edge zone of the support belt can include a portion of the support belt not covered by the fibrous material web during impingement with the impinging steam.

The at least the edge zone of the support belt may include in a width area between about 50 and 1000 mm.

Moreover, the cooling device can be structured and arranged to cool an entire width of the support belt. 1

In accordance with still another feature of the invention, the cooling device may be divided into cooling zones arranged transversely to a belt run direction. Each cooling zone can be structured and arranged to cool with differing intensities. Further, each cooling zone can be structured and arranged to be separately controllable. Still further, a cooling capacity of each cooling zone can be separately controllable.

According to a further feature of the instant invention, the at least one cooling device can include nozzles structured and arranged to supply a cooling medium. The cooling medium can include at least one of liquid and compressed-air. Further, the cooling medium may include a liquid having a boiling temperature lower than a maximum admissible temperature of the support belt. Moreover, the liquid can include one of water and alcohols, and preferably, the liquid comprises polyethylene glycol. Still further, at least one of guide elements, collection devices, and suction devices can be arranged to draw off at least one of the cooling medium rebounded from the support belt and water spray resulting the rebounded cooling medium. Also, at least one of pressure and cooling medium flow rate can be separately controllable. Further, at least one of pressure and cooling medium flow rate may be zonally controllable. Further still, at least one of pressure and cooling medium flow rate can be separately and individually controllable.

A cooling capacity of the cooling device can be adjustable.

According to still another feature of the present invention, the cooling capacity can be controllable in accordance with a heating capacity of the impinging stream device.

In accordance with a still further feature of the invention, a cooling capacity of the cooling device can be regulated in accordance with a temperature of the support belt. Further, the cooling capacity may be zonally regulated in accordance with a temperature of a corresponding support belt zone.

A tear recognition device can be located upstream from the impinging stream device, and a cooling capacity of the cooling device can be controllable in accordance with a signal from the upstream tear recognition indicating a tear of the fibrous material web.

According to another feature of the instant invention, the support belt may include a screen.

A backup roll may be arranged to support the support belt during impingement of the fibrous material web with the impinging stream. The impinging stream device can include a drying hood positioned in a circumferential area of the backup roll.

The support belt may be cooled in a region outside a portion structured for guiding the fibrous material web.

The present invention is directed to a process for drying a fibrous material web in an impinging stream dryer. The process includes supporting a side of the fibrous material web on an air-permeable, endlessly circulating support belt, impinging an opposite side of the fibrous material web with an impinging stream, and cooling at least an edge zone of the support belt that is directly impinged with the impinging stream.

In accordance with a feature of the invention, the at least the edge zone can include a portion of the support belt not covered by the fibrous material web during impingement by the impinging stream.

Further, the impinging stream can include at least one of a hot air and a superheated steam impinging stream.

According to the process of the present invention, an entire width of the support belt can be cooled.

According to the process of the instant invention, the cooling of the support belt may occur after the fibrous material web is transferred to a downstream device.

The support belt can be zonally cooled. Further, each zone can be separately cooled.

In accordance with still yet another feature of the present invention, the cooling may include spraying at least the edge zone of the support belt with a cooling medium composed of at least one of liquid and compressed air. The cooling medium may include a liquid having a boiling temperature lower than a maximum admissible temperature of the support belt. Further, the cooling medium can include one of water and alcohols. Moreover, the cooling medium may include polyethylene glycol.

Other exemplary embodiments and advantages of the present invention may be ascertained by reviewing the present disclosure and the accompanying drawing.

### BRIEF DESCRIPTION OF THE DRAWINGS

The present invention is farther described in the detailed description which follows, in reference to the noted plurality of drawings by way of non-limiting examples of exemplary embodiments of the present invention, in which like reference numerals represent similar parts throughout the several views of the drawings, and wherein:

FIG. 1 schematically illustrates a cross section through a drying arrangement with drying hood and cooling device;

FIG. 2 illustrates a partial section II-II depicted in FIG. 1; and

FIG. 3 illustrates a partial section III-III depicted in FIG. 1.

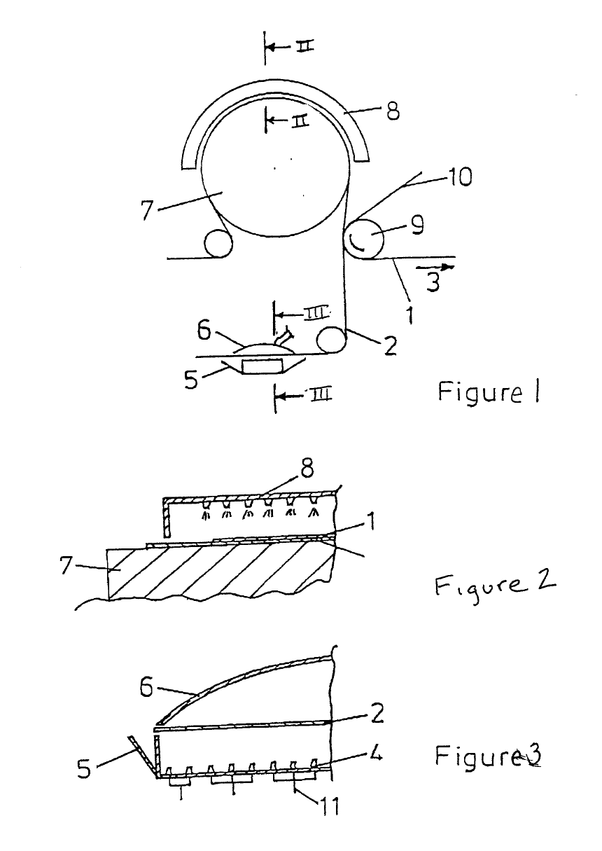

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

The impinging stream dryer is part of a paper machine for drying the fibrous material web 1 and is formed essentially by a rotating backup roll 7 and a drying hood 8. The drying hood 8 is arranged at a distance of a few centimeters from the backup roll 7 and extends over a large part of the circumference of the backup roll 7.

The backup roll 7 is wrapped around by an endlessly circulating support belt 2 in the form of a dryer screen and by the fibrous material web 1 located outside. From the drying hood 8 arranged in the wrap area, the impinging of the fibrous material web 1 is carried out with hot air, which leads to drying of the fibrous material web 1. To this end, several nozzles directed at the fibrous material web 1 are available in the drying hood 8, as illustrated in FIG. 2. The support belt 2 is inevitably wider than the fibrous material web 1. Particularly in the case of a changing width of the fibrous material web 1, this leads to an edge zone of the support belt 2 being exposed directly, i.e., without a fibrous material web 1 lying between it, to the hot air, which, due to the plastic content in the support belt 2, can lead to thermal damage of the same.

After the drying hood 8, the support belt 2 guides the fibrous material web 1 from the backup roll 7 to a guide roll 9 wound around and suctioned by an air-permeable screen 10. The guide roll 9 supports the transfer of the fibrous material web 1 to the screen 10 by the vacuum.

After the transfer of the fibrous material web 1, the support belt 2 is cooled over its entire width by a cooling device in the form of water nozzles 4, as illustrated in FIG. 3. The edge zone of the support belt 2 that is directly exposed to the hot air is thereby cooled with particular intensity.

The water nozzles 4 are located in a hood open to the support band 2 and are arranged in several rows one behind the other running at transverse to the web running direction 3.

The cooling of the support belt 2 takes place at differing intensities in cooling zones delineated transverse to the web running direction 3. In order to be able to separately control the cooling capacity assigned to the cooling zones, the water nozzles 4 of the relevant cooling zone are connected with a joint pressure line 11 that can be controlled by a valve.

The edge of the support belt 2 with a width of between about 200 and 400 mm is cooled the strongest, as that is where the greatest thermal strain takes place.

However, the cooling capacity is also increased in the case of a tear of the fibrous material web 1 in an upstream unit of the paper machine over the entire width. In the control of the cooling capacity, the heating capacity of the drying hood 8 and the temperature of the support belt 2 registered by sensors are also taken into consideration.

In order to reduce the strain on the surroundings by the water spray produced by cooling, there is a suction device 6 connected with a vacuum source on the side of the support belt 2 opposite the water nozzles 4. Furthermore, in the area of the water nozzles 4, i.e., the hood surrounding them, there are collecting devices 5 for the water dripping from the support belt 2, which can likewise have a suction.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. An impinging stream dryer for drying a fibrous material web, comprising:
an air-permeable, endlessly circulating support belt structured and arranged to support a side of the fibrous material web;
a device for impinging an opposite side of the fibrous material web with an impinging stream; and
a belt cooling device arranged to cool at least an edge zone of said support belt that is directly impinged with the impinging stream.

2. The impinging steam dryer in accordance with claim 1, wherein the fibrous material web comprises one of a paper, cardboard, and tissue web.

3. The impinging steam dryer in accordance with claim 1, wherein the impinging stream comprises at least one of a hot air and a superheated steam impinging stream.

4. The impinging steam dryer in accordance with claim 1, wherein said cooling device is positioned so that the cooling of said support belt occurs after a transfer of the fibrous material web said support belt to a downstream device.

5. The impinging steam dryer in accordance with claim 1, wherein said at least said edge zone of said support belt comprises a portion of said support belt not covered by the fibrous material web during impingement with the impinging steam.

6. The impinging steam dryer in accordance with claim 1, wherein said at least said edge zone of said support belt comprises in a width area between about 50 and 1000 mm.

7. The impinging steam dryer in accordance with claim 1, wherein said cooling device is structured and arranged to cool an entire width of said support belt.

8. The impinging steam dryer in accordance with claim 1, wherein said cooling device is divided into cooling zones arranged transversely to a belt run direction.

9. The impinging steam dryer in accordance with claim 8, wherein each cooling zone is structured and arranged to cool with differing intensities.

10. The impinging steam dryer in accordance with claim 8, wherein each cooling zone is structured and arranged to be separately controllable.

11. The impinging steam dryer in accordance with claim 8, wherein a cooling capacity of each cooling zone is separately controllable.

12. The impinging steam dryer in accordance with claim 1, wherein said at least one cooling device comprises nozzles structured and arranged to supply a cooling medium.

13. The impinging steam dryer in accordance with claim 12, wherein said cooling medium comprises at least one of liquid and compressed-air.

14. The impinging steam dryer in accordance with claim 13, wherein said cooling medium comprises a liquid having a boiling temperature lower than a maximum admissible temperature of said support belt.

15. The impinging steam dryer in accordance with claim 14, wherein said liquid comprises one of water and alcohols.

16. The impinging steam dryer in accordance with claim 15, wherein said liquid comprises polyethylene glycol.

17. The impinging steam dryer in accordance with claim 13, further comprising at least one of guide elements, collection devices, and suction devices arranged to draw off at least one of said cooling medium rebounded from said support belt and water spray resulting said rebounded cooling medium.

18. The impinging steam dryer in accordance with claim 13, wherein at least one of pressure and cooling medium flow rate are separately controllable.

19. The impinging steam dryer in accordance with claim 13, wherein at least one of pressure and cooling medium flow rate are zonally controllable.

20. The impinging steam dryer in accordance with claim 1, wherein at least one of pressure and cooling medium flow rate are separately and individually controllable.

21. The impinging steam dryer in accordance with claim 1, wherein a cooling capacity of said cooling device is adjustable.

22. The impinging steam dryer in accordance with claim 1, wherein said cooling capacity is controllable in accordance with a heating capacity of said impinging stream device.

23. The impinging steam dryer in accordance with claim 1, wherein a cooling capacity of said cooling device is regulated in accordance with a temperature of said support belt.

24. The impinging steam dryer in accordance with claim 23, wherein said cooling capacity is zonally regulated in accordance with a temperature of a corresponding support belt zone.

25. The impinging steam dryer in accordance with claim 1, further comprising a tear recognition device located upstream from said impinging stream device, wherein a cooling capacity of said cooling device is controllable in accordance with a signal from said upstream tear recognition indicating a tear of the fibrous material web.

26. The impinging steam dryer in accordance with claim 1, wherein said support belt comprises a screen.

27. The impinging steam dryer in accordance with claim 1, further comprising a backup roll arranged to support said support belt during impingement of the fibrous material web with the impinging stream.

28. The impinging steam dryer in accordance with claim 27, said impinging stream device comprising a drying hood positioned in a circumferential area of said backup roll.

29. The impinging steam dryer in accordance with claim 1, wherein said support belt is cooled in a region outside a portion structured for guiding the fibrous material web.

30. A process for drying a fibrous material web in an impinging stream dryer, the process comprising:
supporting a side of the fibrous material web on an air-permeable, endlessly circulating support belt;
impinging an opposite side of the fibrous material web with an impinging stream; and
cooling at least an edge zone of the support belt that is directly impinged with the impinging stream.

31. The process in accordance with claim 30, wherein the at least the edge zone comprises a portion of the support belt not covered by the fibrous material web during impingement by the impinging stream.

32. The process in accordance with claim 30, wherein the impinging stream comprises at least one of a hot air and a superheated steam impinging stream.

33. The process in accordance with claim 30, wherein an entire width of the support belt is cooled.

34. The process in accordance with claim 30, wherein the cooling of the support belt occurs after the fibrous material web is transferred to a downstream device.

35. The process in accordance with claim 30, wherein the support belt is zonally cooled.

36. The process in accordance with claim 35, wherein each zone is separately cooled.

37. The process in accordance with claim 30, wherein the cooling comprises spraying at least the edge zone of the support belt with a cooling medium composed of at least one of liquid and compressed air.

38. The process in accordance with claim 37, wherein the cooling medium comprises a liquid having a boiling temperature lower than a maximum admissible temperature of the support belt.

39. The process in accordance with claim 38, wherein the cooling medium comprises one of water and alcohols.

40. The process in accordance with claim 37, wherein the cooling medium comprises polyethylene glycol.
